(19) United States
(12) Patent Application Publication
(10) Pub. No.: US 2026/0080870 A1
(43) Pub. Date: Mar. 19, 2026

(54) IN-CONTENT VOICE COMMERCE ENGINE

(71) Applicant: Stephen M. Byrd, Upper Marlboro, MD (US)

(72) Inventor: Stephen M. Byrd, Upper Marlboro, MD (US)

(21) Appl. No.: 19/321,704

(22) Filed: Sep. 8, 2025

Related U.S. Application Data
(63) Continuation-in-part of application No. 16/823,370, filed on Mar. 19, 2020, now abandoned.
(63) Continuation-in-part of application No. 17/408,858, filed on Aug. 23, 2021, now abandoned.

(51) Int. Cl. G10L 15/22; G06Q 30/0601; G06Q 30/08; G10L 15/00; G10L 15/08; G10L 15/18

(52) U.S. Cl. CPC G10L 15/22; G06Q 30/0643; G10L 15/005; G10L 15/1815; G06Q 30/0631; G06Q 30/08; G10L 2015/088

(57) ABSTRACT

The invention provides a system and method for enabling real-time, voice-activated commerce directly within audiovisual content. A viewer identifies and purchases products displayed in programming by issuing natural language commands. The system integrates merchant-uploaded “digital twins” of products, streaming content analysis via metadata or AI-powered visual recognition, and contextual interpretation of viewer queries. In some embodiments, the system supports multilanguage functionality, enabling automatic detection of a viewer's spoken language or selection of a preferred profile, with localized processing of queries and presentation of product information and overlays. The invention performs end-to-end commerce execution within the television or streaming platform, including product identification, presentation, and secure transaction using pre-linked payment accounts. A monetization framework ensures only registered and verified products are presented in response to queries, creating a controlled, scalable revenue model for brands and content originators. The system further extends into AR, VR, and mixed reality environments.

### CROSS REFERENCE TO RELATED APPLICATIONS

The present application is a Continuation-In-Part application of U.S. patent application Ser. No. 16/823,370 filed on 19 Mar. 2020, and Ser. No. 17/408,858 filed on 23 Aug. 2021, which are herein incorporated in their entirety.

### FIELD OF THE DISCLOSURE

The present disclosure relates generally to systems and methods for interactive electronic commerce, and more particularly to voice-activated systems for enabling real-time purchasing of products identified within audiovisual or extended reality content.

### BACKGROUND OF THE RELATED ART

The rise of digital commerce has transformed how consumers interact with products and services. Increasingly, purchasing decisions are influenced by digital platforms, streaming media, and interactive technologies. Companies across industries are seeking innovative ways to capture consumer attention at the point of engagement and provide frictionless purchasing experiences.

Voice-enabled digital assistants have become widely adopted in homes, smartphones, and smart devices. These assistants are powered by artificial intelligence and natural language processing, enabling users to perform tasks such as searching for information, setting reminders, or making purchases with simple voice commands. Their integration into daily life demonstrates the convenience and efficiency of voice-driven interaction.

However, current digital commerce solutions remain largely limited to web-based platforms, standalone applications, or advertisements separate from the content being consumed. There is an increasing need for systems that integrate commerce seamlessly into audiovisual and immersive experiences, allowing users to engage directly with products shown on-screen in real time.

### DESCRIPTION OF RELATED ARTS

U.S. Pat. No. 5,774,664 (Hidary) discloses a system for synchronizing broadcast television signals with associated web content to enable product purchases through linked websites. In this approach, metadata is pre-associated with television programming, allowing a user to access a companion website that contains links to advertised or featured products. However, the Hidary system is limited by its dependence on static synchronization tables and predetermined web links. The user must leave the viewing environment to complete a purchase, resulting in a fragmented and non-seamless commerce flow.

U.S. Pat. No. 9,928,532 (Torres) describes methods for enabling product identification through consumer-submitted still images or video clips. The consumer captures content from a program, uploads it to a vendor platform, and waits for a match and response from third-party sellers. While this approach allows for product identification, it requires manual steps by the consumer, introduces delays in the transaction process, and relies on external vendor systems. These limitations prevent real-time purchasing directly within the viewing experience.

Other prior art systems have focused on digital shopping assistants, online recommendation engines, or mobile commerce applications. For instance, web-based platforms have been designed to suggest products based on browsing behavior, and mobile apps allow scanning barcodes or QR codes to obtain product information. While these solutions improve product discovery, they remain disconnected from audiovisual content and fail to leverage voice interaction as the primary mode of engagement.

Intelligent digital assistants, such as those disclosed in various patents assigned to major technology companies, provide natural language interaction for information retrieval, scheduling, or online shopping. While effective as general-purpose tools, these assistants are not specifically designed to integrate with live audiovisual streams or to monetize the content itself. Their commerce capabilities typically redirect users to external e-commerce platforms, again fragmenting the transaction experience.

Accordingly, none of the above prior art teaches or suggests a system that combines real-time audiovisual content analysis, AI-powered contextual recognition, and natural language voice commands into a unified commerce engine. In particular, no prior art discloses a voice-first monetization framework in which only registered and verified product entries are eligible for presentation, thereby enabling a controlled, scalable, and platform-level revenue model for content originators.

### SUMMARY OF THE INVENTION

The present invention provides a system and method for enabling real-time, voice-activated commerce directly within audiovisual and immersive media content. The invention is designed to allow viewers to identify and purchase products displayed in programming through natural language commands, thereby transforming the way content is monetized.

Unlike conventional systems that rely on static synchronization tables, hyperlink redirection, or user-submitted images, the present invention delivers a seamless, end-to-end transaction flow within the same environment in which the content is consumed. The system integrates product metadata, audiovisual stream analysis, and voice processing into a unified architecture that executes commerce transactions without leaving the content experience.

In one embodiment, merchants, brands, or studios register products into the platform by uploading “digital twins. ” These digital entries include product images, metadata, descriptive attributes, pricing, and availability. The registration process ensures that all products are catalogued in a structured format, enabling accurate and reliable matching during user queries.

The system continuously processes audiovisual content, either through pre-loaded, time-stamped metadata or through real-time AI-powered recognition of objects and scenes. This content awareness allows the invention to dynamically associate products with on-screen events, characters, or items at the moment they appear.

When a viewer issues a voice command, such as “Hey Voicee, what shoes is he wearing? ” the system captures the wake word, interprets the query, and cross-references the identified scene or frame with the database of registered products. By combining contextual recognition with natural language processing, the system ensures accurate and context-specific product identification.

Once a match is found, the system generates an actionable response. This response may include both a voice output delivered through the playback device and a visual overlay displayed non-intrusively on the screen. The response typically presents product information such as name, description, price, and availability, along with an option to complete the purchase.

A critical aspect of the invention is its monetization framework. Only products that have been registered and verified within the platform are eligible to be surfaced in response to user queries. This framework creates a controlled marketplace that prevents unauthorized or unverified products from being presented, ensuring both trust and revenue control.

In some embodiments, the monetization framework incorporates an auction-based system. Brands or studios may bid for priority placement, ensuring their products are favored in situations where multiple relevant items exist. This “tollbooth” model creates scalable revenue opportunities for content owners, platform providers, and advertisers.

In preferred embodiments, the invention completes transactions natively within the television, streaming, or immersive environment. Secure, pre-linked payment accounts allow purchases to be authorized and confirmed with simple voice inputs, such as “Yes, add to cart.” The user receives immediate confirmation via on-screen and voice feedback, minimizing friction in the purchasing process.

Alternative embodiments may support multiple payment gateways, loyalty points, or subscription-based commerce models. For example, a streaming platform may bundle exclusive product offers as part of a premium subscription, with the system handling all underlying transaction logistics.

The invention is designed to be platform-agnostic. It can be implemented across smart televisions, streaming devices, mobile applications, and cloud-based platforms. Its modular architecture ensures compatibility with existing media infrastructure and allows integration into both proprietary and third-party systems.

Beyond traditional television and streaming content, the invention extends into immersive and extended reality environments. Within augmented reality (AR), virtual reality (VR), and mixed reality (MR) experiences, the system enables voice-driven product discovery directly within spatial content. For example, a user wearing VR goggles may ask about an item worn by a virtual character and instantly receive product information and purchase options.

In XR environments, the system leverages three-dimensional contextual analysis to identify products embedded in virtual worlds. This expands the scope of commerce beyond real-world media into synthetic and interactive spaces, positioning the invention as a universal engine for in-content monetization.

The invention may also incorporate personalization features. By leveraging user profiles, preferences, and past purchase history, the system can tailor responses to individual viewers. For instance, two users may see different product recommendations for the same scene, based on their interests and demographics.

In some embodiments, the system may support localized product availability. A query for an item may return different purchasing options depending on the viewer's geographic region, with pricing and shipping tailored accordingly.

The invention further enables analytics and reporting. Content owners and merchants can access insights into viewer interactions, query volume, and purchase conversions. This data can be used to optimize content-product placement and refine marketing strategies.

Security and privacy are integral to the system. All transactions are executed over secure, encrypted channels, and user data is protected in compliance with privacy regulations. Payment details are tokenized, ensuring sensitive information is never exposed.

In some embodiments, parental control or content filtering features may be included. This ensures that product offers are age-appropriate and aligned with user preferences.

The system may also support offline or asynchronous modes. For example, a user may issue a query during a live program and later receive purchase options via a linked mobile application or email.

The invention can also integrate with social commerce platforms. A viewer may share a product discovered in a scene with friends on social media, with the system tracking engagement and driving additional sales.

From a technical perspective, the system is built on a layered architecture comprising input processing (merchant, content, and viewer inputs), core processing (contextual recognition, database matching, and response generation), and output delivery (voice and visual responses, transaction execution).

This architecture ensures scalability, as each layer can be distributed across cloud infrastructure, edge devices, or embedded modules within playback hardware. Such scalability enables adoption across diverse markets and device ecosystems.

The invention is not limited to consumer entertainment. It may also be applied in educational programming, live sports, or professional training environments where in-content products, services, or tools can be instantly explored and purchased by the audience.

Accordingly, the invention delivers a transformative model for media monetization. It allows brands and content creators to establish new revenue streams, provides consumers with frictionless purchasing experiences, and redefines the role of voice interaction in digital commerce.

In summary, the present invention provides a voice-first, AI-enabled commerce engine that integrates real-time contextual recognition, secure end-to-end transactions, and a controlled monetization framework within audiovisual and immersive environments. By unifying these capabilities, the invention addresses the shortcomings of prior art and establishes a scalable foundation for the next generation of in-content commerce.

In certain embodiments, the system supports multilanguage voice recognition and localization, allowing viewers to engage in commerce in their preferred language across global markets.

### BRIEF DESCRIPTION OF THE DRAWINGS

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1 is a block diagram illustrating the overall architecture of the In-Content Voice Commerce Engine, showing the interaction between merchant input, content analysis, viewer voice input, and system outputs, according to some embodiments of the present disclosure.

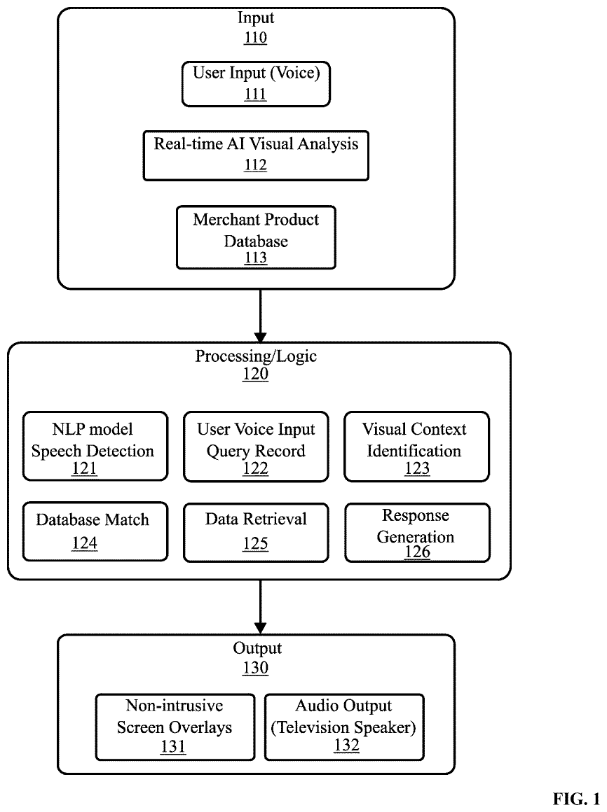

FIG. 2 is a flow diagram illustrating the operational process of the system, including content recognition, contextual query interpretation, database matching, and generation of actionable responses, according to some embodiments of the present disclosure.

FIG. 3 is a schematic diagram illustrating an example user interaction sequence, in which a viewer issues a voice command, receives product details via voice and on-screen overlay, and completes a transaction using a secure pre-linked account, according to some embodiments of the present disclosure.

### DETAILED DESCRIPTION OF THE INVENTION

Unless otherwise defined, all technical terms used herein related to voice recognition, natural language processing, artificial intelligence, machine learning, audiovisual content analysis, and electronic commerce systems have the same meaning as commonly understood by one of ordinary skill in the relevant arts of speech processing, digital assistants, media analysis, and online commerce. Terms such as “speech recognition,” “natural language understanding,” “digital twin,” “extended reality,” “overlay,” “product registry,” and other technical phrases commonly used in the fields of voice commerce and media systems should be interpreted consistently with their conventional usage in the context of this specification and the current state of multimedia commerce technology. These terms should not be interpreted in an idealized or overly formal sense unless expressly defined herein. For clarity, well-known functions or structures relating to voice processing, content recognition, or e-commerce platforms may not be described in exhaustive detail.

The terminology used herein is intended to describe particular embodiments of the in-content voice commerce system and is not intended to be limiting. As used herein, singular forms such as “a voice capture module,” “an overlay generator,” or “a commerce engine” are intended to include plural forms as well, unless the context clearly indicates otherwise. Similarly, references to “voice query,” “product registry,” or “transaction” should be understood to include multiple instances or variations of such elements, where applicable.

With reference to the use of the words “comprise,” “comprises,” or “comprising” in describing the components, processes, or functionalities of the system, and in the following claims, unless the context requires otherwise, these words are used on the basis and clear understanding that they are to be interpreted inclusively rather than exclusively. For example, when referring to “comprising a product matcher,” the term should be understood to mean including but not limited to the described product matching functionality, and may encompass additional related modules or methods not explicitly described. Each instance of these words is to be interpreted inclusively in construing the description and claims, particularly given the modular and adaptable nature of the system disclosed herein.

Furthermore, terms such as “connected,” “coupled,” “in communication with,” or “operatively linked” as used in describing the interaction between modules of the system (such as between the voice processing pipeline and the context engine) should be interpreted to include both direct connections and indirect connections through one or more intermediary components, unless explicitly stated otherwise. References to operations such as “processing,” “analyzing,” “identifying,” “matching,” or “generating” should be understood to encompass both real-time and delayed processing, synchronous or asynchronous operation, and local or cloud execution, unless specifically limited to one or the other in context.

In some embodiments, the in-content voice commerce system 100 may operate entirely within a smart television, wherein the modules including the voice capture and processing pipeline 120, the content ingestion layer 110, the product matcher 130, and the overlay compositor 142 are pre-installed as part of the television's native firmware or operating system. In other embodiments, system 100 may execute as a streaming media application, where the modules run within an app environment and communicate with cloud servers for heavy processing tasks. In still other embodiments, system 100 may be deployed through a set-top box coupled to a display, where the set-top box executes the components described herein. In some configurations, system 100 may leverage a mobile companion application, wherein a smartphone captures viewer voice input and synchronizes it with audiovisual playback, relaying queries to the cloud while maintaining alignment with the content. In certain embodiments, deployment may be distributed across edge devices and cloud infrastructure, such that wake-word detection occurs locally within the ASR module 122, while higher-level NLU processing 124 and product matching 130 are executed in cloud services. This hybrid architecture allows system 100 to minimize latency while preserving user privacy and scalability.

In some embodiments, merchants, brands, or content providers may register products with system 100 via the merchant onboarding interface 102. Products may be uploaded as digital twins comprising metadata fields such as name, brand, model, size, material, and category; image assets; and optionally, three-dimensional models. In certain embodiments, the digital twin may also include pricing information, inventory availability, shipping constraints, and scene associations linking the product to specific audiovisual moments. The product registry 104 may store digital twins in a standardized schema to enable efficient querying. In some embodiments, registry 104 may also include a verification service to authenticate merchant identity and validate product authenticity before activation. Verified products may be tagged with a secure token or identifier to ensure they are eligible for surfacing in response to viewer queries.

In some embodiments, the content ingestion layer 110 may operate in a metadata-driven mode, wherein pre-authored, time-stamped annotations provided by content producers are ingested through APIs. These annotations may include product identifiers, scene identifiers, and timestamp alignments. In other embodiments, the content ingestion layer may operate in a real-time recognition mode, applying AI-based visual recognition and audio analysis models to detect objects and contexts directly from the media stream. For example, a convolutional neural network may identify a handbag, while an audio classifier may detect a product mention in dialogue. In still other embodiments, both metadata-driven and recognition-driven modes may run concurrently, ensuring redundancy and maximizing recognition accuracy. In some configurations, the content ingestion layer 110 may include adaptive learning mechanisms to update its detection models based on user feedback, analytics from service 160, or content re-releases.

In some embodiments, viewer input may be received via a voice interface integrated into a television remote, microphone array, or mobile device. A wake-word detector may activate the capture function of the ASR module 122. The ASR module may then transcribe the spoken input into text, which is passed to the NLU module 124. The NLU may extract intents (e.g., “purchase,” “compare,” “identify”) and entities (e.g., “dress,” “red shoes,” “suitcase”), producing a structured query for downstream processing.

In some embodiments, the context engine 126 may normalize synonyms, resolve pronouns, and bind interpreted utterances to the active audiovisual context supplied by ingestion layer 110. For instance, if a user asks “What is she wearing? ” while a specific character is onscreen, context engine may link the pronoun “she” to the character identity and determine the objects of interest from the ingestion data. This contextual reconciliation generates a candidate set of objects for evaluation by the product matcher 130.

In some embodiments, the product matcher 130 may query the product registry 104 to determine if one or more candidate objects correspond to registered digital twins. In certain embodiments, matcher may also apply ranking algorithms incorporating visual similarity metrics, metadata correlations, contextual weights from engine 126, and monetization rules. In scenarios where multiple candidates exist, matcher 130 may calculate confidence scores and return either the highest-ranked result or a disambiguation set.

In some embodiments, once a product match is identified, response generator 140 may create a multimodal response. Overlay compositor 142 may generate an on-screen overlay showing product name, description, price, availability, and merchant branding, while a text-to-speech component provides verbal confirmation. In certain embodiments, overlay compositor may also render interactive elements, such as “Add to Cart” or “View Similar Items,”navigable via remote or voice command.

In some embodiments, upon user confirmation, commerce engine 150 may initiate a transaction by communicating with payment gateway 152 and account manager 154. Payment gateway may handle authorization with financial institutions, while account manager 154 may retrieve securely stored user credentials. In certain embodiments, commerce engine may support multiple payment types including credit/debit cards, digital wallets, and loyalty programs.

In some embodiments, after purchase, system 100 may generate confirmations through multiple channels. Overlay compositor 142 may display a success indicator, while response generator 140 may provide a spoken confirmation. Receipts may be sent via email, SMS, or push notification. In certain embodiments, overlays may also present estimated shipping dates, return windows, or tracking options.

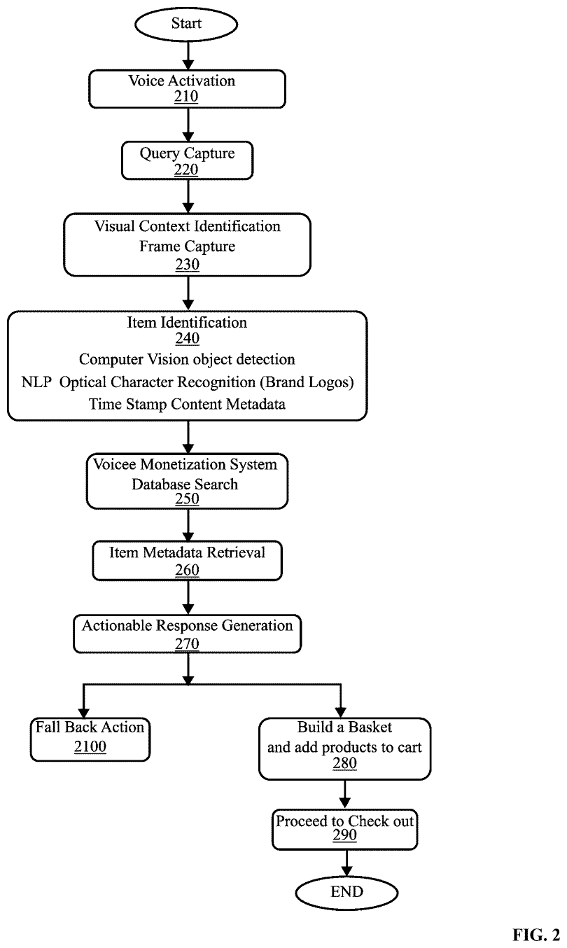

As illustrated in FIG. 2, in some embodiments the process flow of system 100 may proceed through: wake-word detection, ASR transcription 122, NLU interpretation 124, context reconciliation 126, candidate object identification via ingestion layer 110, product matching 130, monetization validation, response generation 140, overlay rendering 142, commerce execution 150-154, and analytics logging via service 160.

In some embodiments, if matcher 130 fails to locate a registered product in registry 104, response generator 140 may output a fallback notification that no purchasable item is available. In other embodiments, overlay compositor 142 may present an option to subscribe for alerts, wherein the viewer consents to be notified once the product becomes registered.

In some embodiments, if multiple candidate products are matched with similar confidence scores, system 100 may trigger a disambiguation dialog. Overlay compositor 142 may display visual thumbnails, while response generator 140 prompts the viewer with options (e.g., “Did you mean the red jacket or the blue jacket? ”).

In some embodiments, system 100 may adapt its responses to regional contexts, presenting localized pricing, currency formats, and shipping options. If the requested product is unavailable in the viewer's region, matcher 130 may substitute equivalent alternatives from registry 104.

In some embodiments, personalization may be supported by integrating user data within account manager 154, wherein recommendations adapt based on purchase history, saved preferences, or demographic settings. In certain embodiments, personalization may be opt-in only and regulated by privacy manager 162, ensuring compliance with user consent requirements.

In some embodiments, the monetization framework ensures that only verified products in registry 104 are surfaced in viewer interactions. In certain embodiments, an auction mechanism may be implemented, wherein merchants bid for query priority, and matcher 130 applies monetization rules to rank eligible candidates accordingly.

In some embodiments, system security may be enforced by privacy manager 162, which ensures encrypted communications, tokenized payments, and data minimization policies. Parental control settings within privacy manager 162 may further restrict categories of products or require secondary authentication for purchases.

In some embodiments, system 100 may extend to immersive AR, VR, or MR environments, where overlay compositor 142 renders three-dimensional product models spatially aligned to the scene. Commerce engine 150 may then complete purchases without requiring users to leave the immersive environment.

In some embodiments, account manager 154 may support multi-user profiles, each linked to unique voice signatures, enabling differentiation of household members. In certain embodiments, accessibility features including high-contrast overlays, adjustable text scaling, and compatibility with screen readers may be provided to accommodate users with disabilities.

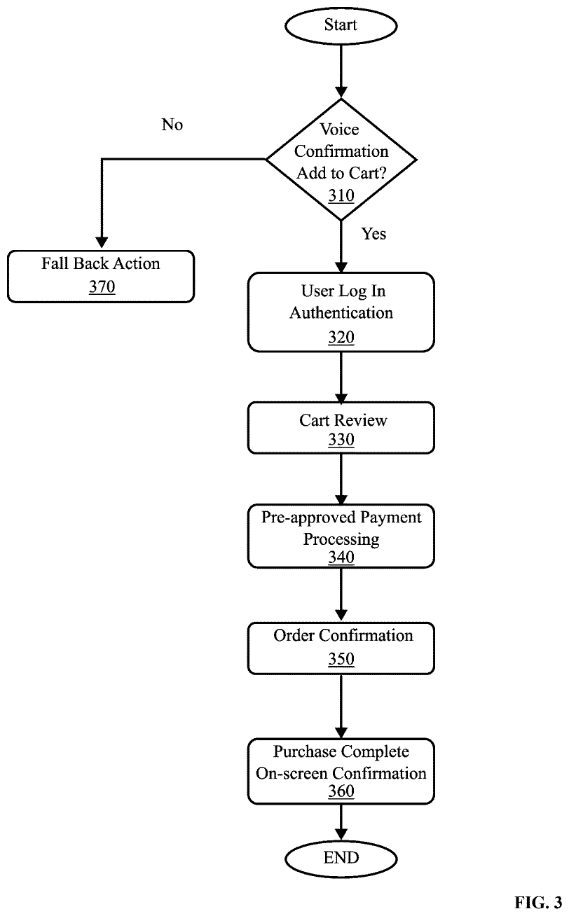

As illustrated in FIG. 3, in some embodiments a user interaction flow may involve a viewer issuing a voice command, ASR 122 and NLU 124 parsing the request, context engine 126 linking it to the audiovisual moment, matcher 130 identifying a product from registry 104, and response generator 140 with overlay compositor 142 presenting results. Upon confirmation, commerce engine 150 finalizes the purchase through gateway 152 and account manager 154.

In some embodiments, analytics service 160 may log query frequencies, match success rates, transaction conversions, and user engagement data. In certain embodiments, analytics data may be anonymized and aggregated before being shared with merchants or content providers.

In some embodiments, registry 104 may maintain a version-controlled schema, allowing merchants to update product details such as price or attributes without disrupting existing associations. This ensures that legacy content remains monetizable even when product lines evolve.

In some embodiments, integration with content studios may occur through APIs that accept metadata submissions aligned with industry identifiers such as EIDR codes. In other embodiments, ingestion layer 110 may align recognition outputs with standardized content identifiers for interoperability.

In some embodiments, system 100 may be optimized for low-latency operation, maintaining less than one-second delay between query input and overlay rendering. Optimizations may include streaming ASR 122, incremental NLU 124, and predictive pre-rendering of overlays by compositor 142.

In some embodiments, offline or asynchronous functionality may be supported, wherein viewer queries are captured and stored locally and later synchronized through companion applications or account manager 154 once connectivity resumes.

In some embodiments, response generator 140 and analytics service 160 may integrate with social platforms, allowing users to share product discoveries, reviews, or purchase confirmations on social media.

In some embodiments, devices implementing system 100 may comprise processors, memory, and accelerators such as GPUs for vision tasks or DSPs for audio analysis. In other embodiments, system 100 may operate on cloud servers that dynamically allocate compute resources.

In some embodiments, supported user intents may include product identification, price comparison, wishlist addition, and purchase execution. In certain embodiments, NLU 124 may be configured with domain-specific ontologies to recognize commerce-related intents accurately.

In some embodiments, the modules described herein (e.g., ingestion layer 110, matcher 130, commerce engine 150) may be combined, subdivided, or distributed across hardware and software components. References to modules and their numerals in the figures are illustrative and not limiting.

In some embodiments, the system may support multilanguage functionality, wherein the automatic speech recognition module and natural language understanding module are configured to detect and process viewer voice queries across multiple languages. In certain embodiments, the system may automatically identify the language of the voice input and apply language-specific models. In other embodiments, users may preselect a preferred language profile. The system may further support multilingual commerce transactions, wherein product metadata and overlays are localized according to the detected or selected language

It should be understood that the embodiments described herein are illustrative and not restrictive. Modifications, substitutions, and equivalents may be applied without departing from the scope of the invention.

Accordingly, the present disclosure describes a voice-activated commerce engine that integrates real-time contextual recognition, natural language processing, and secure transaction execution into audiovisual and immersive environments, thereby providing a scalable, trusted, and seamless framework for in-content monetization.

What is claimed:

1. A system for enabling real-time, voice-activated commerce within audiovisual content, the system comprising:
a merchant onboarding interface configured to receive digital twins of products from merchants, brands, or content providers, wherein each digital twin includes metadata, images, and product attributes;
a product registry operatively coupled to the onboarding interface, the product registry storing and verifying the digital twins;
a content ingestion layer configured to analyze audiovisual content, the content ingestion layer operable in at least one of a metadata-driven mode and a real-time recognition mode;
a voice capture and processing pipeline comprising an automatic speech recognition module configured to transcribe viewer voice input into text and a natural language understanding module configured to extract intents and entities from the transcribed text;
a context engine configured to reconcile the extracted intents and entities with active audiovisual content and identify candidate objects;
a product matcher configured to query the product registry to determine whether a candidate object corresponds to a registered digital twin;
a response generator comprising an overlay compositor configured to generate multimodal output including an on-screen overlay and an audio confirmation; and
a commerce engine operatively coupled to a payment gateway and an account manager, the commerce engine configured to execute a transaction for the matched product in response to viewer confirmation.

2. The system of claim 1, wherein the digital twins further comprise scene associations linking the product to specific audiovisual moments.

3. The system of claim 1, wherein the content ingestion layer comprises an artificial intelligence module configured to detect products directly from video frames or audio streams.

4. The system of claim 1, wherein the voice capture and processing pipeline further comprises a wake-word detector configured to activate the automatic speech recognition module.

5. The system of claim 1, wherein the context engine is further configured to normalize synonyms and resolve pronouns within the transcribed text.

6. The system of claim 1, wherein the product matcher is further configured to apply ranking algorithms based on metadata similarity, contextual association, and monetization parameters.

7. The system of claim 1, wherein the commerce engine is further configured to support multiple payment methods including credit cards, digital wallets, loyalty programs, or subscription models.

8. The system of claim 1, wherein the overlay compositor is configured to render interactive purchase options directly within the audiovisual stream.

9. The system of claim 1, further comprising an analytics service configured to log interaction data including query types, response rates, and purchase conversions.

10. The system of claim 1, further comprising a privacy manager configured to enforce encrypted communication channels, tokenized payment credentials, and parental control restrictions.

11. The system of claim 1, wherein the monetization framework applies an auction mechanism to prioritize product surfacing when multiple candidates are eligible.

12. The system of claim 1, wherein the overlay compositor is further configured to render three-dimensional overlays within augmented reality, virtual reality, or mixed reality environments.

13. The system of claim 1, wherein the system is further configured to personalize product recommendations based on prior purchases, preferences, or demographic attributes.

14. The system of claim 1, wherein the automatic speech recognition module and the natural language understanding module are further configured to support multiple languages.

15. The system of claim 14, wherein the system is configured to automatically detect a language of the viewer input and apply language-specific processing models.

16. The system of claim 14, wherein the system is further configured to localize overlays and product metadata into a detected or selected language.

17. A method for enabling real-time, voice-activated commerce within audiovisual content, the method comprising:
receiving a digital twin of a product via a merchant onboarding interface;
storing and verifying the digital twin in a product registry;
analyzing audiovisual content via a content ingestion layer to identify objects;
receiving a voice query from a viewer and transcribing the query into text using an automatic speech recognition module;
extracting an intent and one or more entities from the transcribed text using a natural language understanding module;
reconciling the intent and entities with the audiovisual content context using a context engine to identify candidate objects;
querying the product registry using a product matcher to identify a digital twin corresponding to the candidate objects;
generating a multimodal response via a response generator, including rendering an overlay with product information using an overlay compositor; and
executing a purchase transaction for the product via a commerce engine coupled to a payment gateway and an account manager.

18. The method of claim 17, further comprising detecting a language of the viewer voice query and processing the query using a language-specific recognition and understanding model.

19. The method of claim 17, further comprising localizing product information and overlays into a detected or selected language.

20. A non-transitory computer-readable medium storing instructions that, when executed by one or more processors, cause the processors to perform the method of claim 17.
